(19) United States
(12) Patent Application Publication
(10) Pub. No.: US 2007/0107296 A1
(43) Pub. Date: May 17, 2007

(54) Fishing aid

(76) Inventor: Michael E. Hollomon, Hemphill, TX (US)

Correspondence Address: Stephen R. Greiner, Esquire;GREINER LAW OFFICES, P.C., Suite 110, 6701 Democracy Blvd., Bethesda, MD, 20817, US

(21) Appl. No.: 11/272,686

(22) Filed: Nov. 15, 2005

(51) Int. Cl. A01K 85/01; A01K 85/00

(52) U.S. Cl. 43/42.31; 43/42.37; 43/42.24; 43/42.28

(57) ABSTRACT

A fishing aid including a fishhook having an eye and a barb respectively positioned at its opposed ends. A rattle is releasably secured to the fishhook. The rattle has a catch that extends from one of its opposed ends with an open-loop portion for grasping the eye of the fishhook. The rattle also has a sharpened point at the other of its opposed ends for easy insertion into a soft plastic bait.

### FIELD OF THE INVENTION

The present invention relates generally to apparatus for fishing, trapping and vermin destroying and, more particularly, to fishing lures utilizing artificial bait of the type having confined shifting materials that make sounds. BACKGROUND OF THE INVENTION

For generations, fishermen have proposed improvements to lures for attracting and catching fish. One lure design that is now popular and quite effective includes a resilient tube suspended from a single fishhook. The tube trails a number of filaments that wiggle like tentacles when retrieved. Many game fish find the sight of a tube to be an irresistible inducement to strike, but tubes have had a tendency to slide off of conventional fishhooks limiting their effectiveness.

Some fishermen have taken to inserting small rattles into tubes to make sounds that travel through the water during fishing. The sounds are believed to mimic those made by injured prey and draw game fish close to a tube that they cannot initially see. Unfortunately, with only friction holding a rattle in place within a tube, a rattle will sometimes fall out and become lost when a tube bumps into a submerged object or is struck by fish. Worse yet, a rattle can shift about within a tube and prevent a fishhook from engaging and grasping a fish during a strike.

To overcome some of the problems associated with fishing with tubes, fishhooks have been produced with special clasps that penetrate the tube and provide a secondary means for holding the tube in place. Also, wire tethers have been developed for joining rattles to fishhooks. Producing lures with both tube clasps and rattle tethers is costly, and fishing with both is cumbersome.

### SUMMARY OF THE INVENTION

In light of the problems associated with the known apparatus employed to fish with resilient tubes and similar baits, it is a principal object of the invention to provide a fishing aid that securely, compactly, and simultaneously fastens both a rattle and a soft plastic bait to a fishhook. The rattle, in fact, is employed as a means of securement for the bait.

It is another object of the present invention to provide a fishing aid of the type described with a rattle that is easily inserted into a soft plastic bait regardless of whether the bait is hollow or solid in its construction. Once inserted, the rattle anchors itself strongly in place.

It is a further object of the present invention to provide a fishing aid of the type described that is easy to use and can be deployed with minimal instruction and without resort to any tools. The fishing aid is intuitive to use.

It is an additional object of the invention to provide a fishing aid that, when retrieved, has a realistic presence in the water in terms of both appearance and sound. Such a fishing aid will attract and catch more fish than lures now available. For users of the fishing aid, fishing will prove to be a more productive pastime.

It is an object of the invention to provide improved features and arrangements thereof in a fishing aid for the purposes described that is lightweight in construction, inexpensive to manufacture, and fully dependable in use.

Briefly, the fishing aid in accordance with this invention achieves the intended objects by featuring a fishhook having an eye and a barb at its opposite ends. A rattle is releasably secured to the fishhook and includes a hollow tube having opposed ends. At least one ball is loosely positioned within the tube for producing sounds when struck against the hollow tube. A cap closes one of the ends of the tube. The cap has an outwardly extending catch with an open-loop portion for grasping the eye of the fishhook. A plug closes the other one of the ends of the tube. The plug has a sharpened point for easy insertion into a soft plastic bait. The sharpened point is formed by making the plug conical or by adding an outwardly extending spear to it.

The foregoing and other objects, features, and advantages of the present invention will become readily apparent upon further review of the following detailed description of the preferred embodiments as illustrated in the accompanying drawings.

### BRIEF DESCRIPTION OF THE DRAWINGS

The present invention may be more readily described with reference to the accompanying drawings, in which:

FIG. 1 is a perspective view of a fishing aid in accordance with the present invention to which is attached a resilient bait with portions broken away.

FIG. 2 is an exploded perspective view of the fishing aid of FIG. 1.

FIG. 3 is a perspective view of an alternative fishing aid in accordance with the present invention.

FIG. 4 is an exploded perspective view of the alternative fishing aid.

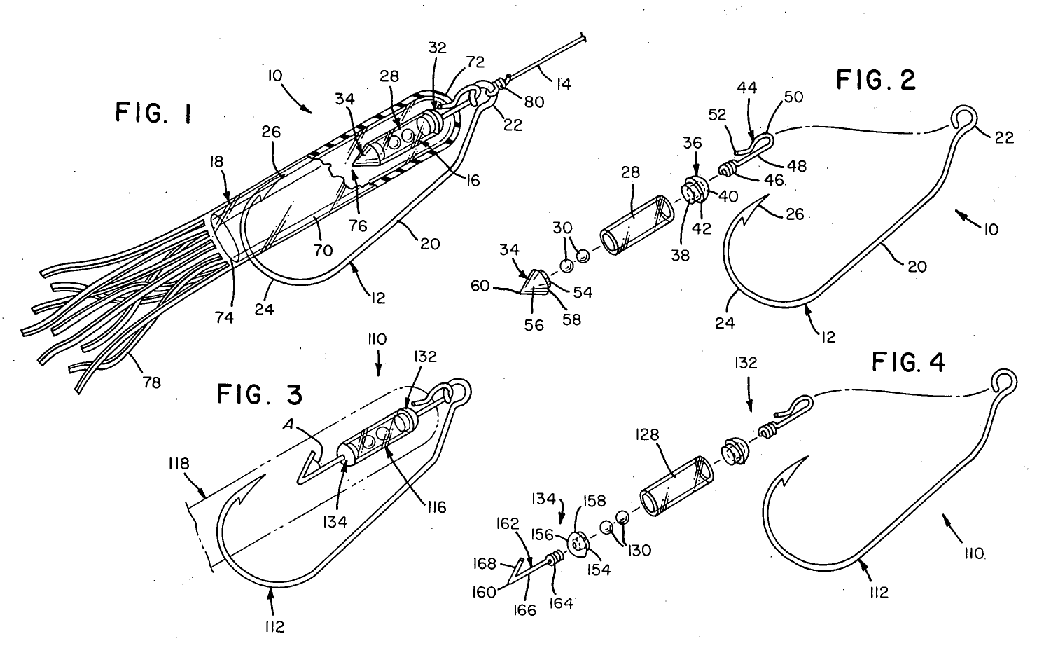

Similar reference characters denote corresponding features consistently throughout the accompanying drawings.

### DETAILED DESCRIPTION OF THE PREFERRED EMBODIMENTS

Referring now to the FIGS., a fishing aid in accordance with the present invention is shown at 10. Fishing aid 10 includes a fishhook 12 attached to the end of a flexible line 14. Carried by fishhook 12 is a rattle 16 for producing sounds that are attractive to game fish. A resilient bait 18 for visually stimulating game fish is secured to line 14 by means of fishhook 12 and rattle 16 that both penetrate bait 18 at spaced-apart points.

Fishhook 12 comprises a stiff piece of wire bent into the shape of a “J”. As shown, fishhook 12 includes an elongated shank portion 20 that comes to an end at its top in a circular eye 22 to which line 14 is tied. A catch portion 24 is integrally formed with the bottom of shank portion 20 and curves backwardly upon shank portion 20 to terminate at a free end adjacent shank portion 20. A barb 26 is formed at the free end of catch portion 24 that is capable of penetrating the mouthparts of a game fish and that points toward eye 22.

Rattle 16 includes a hollow tube 28 with opposed ends that loosely contains a number of steel balls 30 or other items capable of producing sounds when struck against the inner wall of tube 28. A cap 32 closes the top end of tube 28 to hold balls 30 in tube 28. A plug 34, however, closes the bottom end of tube 28 to retain balls 30 therein.

Cap 32 has a stopper 36 with an inner portion 38 for snug positioning within tube 28 and a somewhat larger outer portion 40 that defines a shoulder 42 at the junction of portions 38 and 40 for preventing the over-insertion of stopper 36 into tube 28. Inner portion 38 is cylindrical and has a diameter that is substantially equal to the inner diameter of tube 28. Outer portion 40, on the other hand, is dome-shaped to streamline rattle 16 and has a maximum diameter that is equal to the outer diameter of tube 28 for a flush fit with the outer wall of tube 28.

Cap 32 is provided with a catch 44 formed of wire that is affixed to stopper 36. As shown, catch 44 has a spiral wound portion 46 molded within portions 38 and 40 of stopper 36. A linear stem portion 48 extends outwardly from spiral wound portion 46 and outer portion 40 of stopper 36. An open-loop portion 50 is integrally formed with the outer end of stem portion 48 and curves backwardly upon stem portion 48 to terminate at a free end 52 capable of being extended through eye 22 or around any other desired feature of fishhook 12.

Plug 34 has an inner portion 54 for snug positioning within tube 28 and a somewhat larger outer portion 56 that defines a shoulder 58 at the junction of portions and 54 and 56 for preventing the over-insertion of plug 34 into tube 28. Preferably, inner portion 54 is cylindrical and has a maximum diameter that is equal to the inner diameter of tube 28. Outer portion 56, on the other hand, is cone-shaped, tapering in diameter from its inner end where its diameter is equal to the outer diameter of tube 28 for a flush fit with the outer wall of tube 28 to its outer end which is a sharpened point 60 for easy insertion into resilient bait 18.

In an alternative embodiment of fishing aid 110 shown in FIGS. 3 and 4, a rattle 116 containing steel balls 130 is releasably attached to fishhook 112. Rattle 116 includes a cap 132, identical in all respects to cap 32, and a plug 134 from which a spear 162 extends for insertion into resilient bait 118. Plug 134 has an inner portion 154 for snug positioning within hollow tube 128 and a larger outer portion 156 defines a shoulder 158 at the junction of portions 154 and 156 for preventing the over-insertion of plug 134 into tube 128. Here, inner portion 154 is cylindrical and has a maximum diameter that is equal to the inner diameter of tube 128 and outer portion 156 is dome-shaped, tapering in diameter from its inner end where its diameter is equal to the outer diameter of tube 128 for a flush fit with the outer wall of tube 128.

Spear 162 is formed of wire and is affixed to plug 134. As shown, spear 162 has a spiral 15 wound portion 164 molded within portions 154 and 156 of plug 134. A linear stem portion 166 extends outwardly from spiral wound portion 164 and outer portion 156 of plug 134. A barbed portion 168 is integrally formed with the outer end of stem portion 166 and extends backward therefrom toward plug 134 at an acute angle A. In use, barbed portion 168 catches upon material comprising the interior of resilient bait 118 to lock rattle 116 and bait 118 together. Further, angular junction of portions 166 and 168 defines a sharpened point 160 that can be easily penetrated into bait 118 during the assembly of fishing aid 110.

Tubes 28,128, caps 32,132, and plugs 34,134 can be formed from any materials that a manufacturer finds suitable. Such materials might include plastic compounds, glass, and metal alloys that are durable and not easily corroded by prolonged exposure to water. Aluminum and lead are particularly well-suited metals since they are easily worked and are available at relatively low cost.

Resilient bait 18 includes a tube 70 molded from soft plastic or rubber and having a closed end 72 and an open end 74 that provides access to an interior cavity 76 that is large enough to contain rattle 16. Around open end 74, a number of filaments 78 extend outwardly from tube 70 to simulate tentacles that many game fish instinctively find appealing insofar as food is concerned. Bait 18, however, can take a variety of forms and can simulate animals like minnows, worms, frogs, crayfish, and salamanders, to name a few. Furthermore, bait need not be hollow and possess an interior cavity at the time of its manufacture to be used with fishing aid 10 but, rather, can be solid and possess no internal voids. If the material that a solid bait is formed from is sufficiently plastic, rattle 16 can be pressed inside with a minimum of effort with sharpened point 60 or spear 162 opening a cavity ahead of rattle 16.

The use of fishing aid 10 is straightforward. First, fishhook 12 is tied by a knot 80 to flexible line 14. Next, catch portion 24 of fishhook 12 is pressed through bait 18 midway between closed end 72 and open end 74 such that fishhook barb 26 rests against the side of bait 18 so as to make fishing aid 10 weedless. Then, with rattle 16 secured by means of catch 44 to fishhook eye 22, sharpened point 60 of plug 34 is pressed into the closed end of bait 18 and into cavity 76. Next, with the continued application of a light pushing force, rattle 16 is fully inserted into cavity 76. Now, fishing aid 10 can be put into a body of water in an effort to catch fish with bait 18 being firmly secured to line by both fishhook 12 and rattle 16.

Fishing aid 10 is cast and retrieved in the usual manner by means of a rod and reel (not shown). During retrieval, bait 18 can be given a wiggling action by manipulating the rod and reel to visually simulate a wounded animal that game fish find attractive. Furthermore, the wiggling of rattle 16 thrusts balls 30 against the inner wall of tube 28, cap 32, and plug 34 to produce sonic emanations that travel away from fishing aid 10 to attract fish that cannot immediately see bait 18. When a fish strikes bait 18, a tug is felt on line 14 and fishhook 12 is set in the mouth of the fish by pulling sharply on line 14. After line 14 is reeled in, the just-caught fish can be released from fishhook 12 and either set free or harvested. Use of fishing aid 10, will provide a fisherman with more opportunities to make such a choice than ever before possible.

When a fisherman has caught his limit or has otherwise decided to terminate his fishing efforts, fishing aid 10 can be detached from line 14 and placed in a tackle box for reuse at a convenient time. No further disassembly of fishing aid 10 is required as its compact size lends itself easy storage in a tackle box. Some fishermen who coat baits such as the one shown at 18 with scents and other chemical attractants may choose to detach the bait from fishhook 12 and rattle 16 by reversing the steps for attachment noted above so that the bait can be stored in a sealed container. The process of setting up fishing aid 10 for use or stowing fishing aid 10 after use requires just a few minutes to complete.

It should be appreciated that the use of fishing aid 110 is substantially similar to the use of fishing aid 10. The only substantial difference is that the sharpened point 160 of spear 162 leads the way into the closed end of bait 118 rather than sharpened point 60 of cone-shaped plug 34. With barbed portion 168 of spear 162 penetrating the interior of bait 118, it is exceedingly difficult to loose bait 118 in the water due to a snag or a fish strike. Thus, a fisherman, not having to repeatedly replace bait 118, can pursue his quarry with greater efficiency and at lower cost than has been possible in the past.

While fishing aids 10 and 110 have been described with a high degree of particularity, it will be appreciated by those skilled in the art that modifications can be made to them. Therefore, it is to be understood that the present invention is not limited to the fishing aid embodiments described above, but encompasses any and all embodiments within the scope of the following claims.

1. A fishing aid, comprising:
a fishhook having first opposed ends and an eye at one of said first opposed ends and a barb at the other of said first opposed ends; and,
a rattle being releasably secured to said fishhook, said rattle having second opposed ends and a catch extending from one of said second opposed ends with an open-loop portion for releasably grasping said eye of said fishhook and a sharpened point at the other of said second opposed ends for easy insertion into a soft plastic bait.

2. The fishing aid according to claim 1 wherein one of said second opposed ends of said rattle is conical and defines said sharpened point.

4. A fishing aid, comprising:
a fishhook having first opposed ends and an eye at one of said first opposed ends and a barb at the other of said first opposed ends; and, a rattle being releasably secured to said fishhook, said rattle including:
a hollow tube having second opposed ends;
a ball being loosely positioned within said hollow tube for producing sounds when struck against said hollow tube;
a cap closing one of said second opposed ends of said hollow tube, said cap having an outwardly extending catch with an open-loop portion for releasably grasping said eye of said fishhook; and,
a plug closing the other one of said second opposed ends of said hollow tube, said plug having a sharpened point for easy insertion into a soft plastic bait.

5. The fishing aid according to claim 4 wherein said plug is conical.

7. A rattle for use with a fishhook having first opposed ends and an eye at one of said first opposed ends and a barb at the other of said first opposed ends, said rattle comprising:
a hollow tube having second opposed ends;
at least one ball being loosely positioned within said hollow tube for producing sounds when struck against said hollow tube;
a cap closing one of said second opposed ends of said hollow tube, said cap having an outwardly extending catch with an open-loop portion for releasably grasping the eye of the fishhook; and,
a plug closing the other one of said second opposed ends of said hollow tube, said plug having a sharpened point for easy insertion into a soft plastic bait suspended from the fishhook.

8. The fishing aid according to claim 7 wherein said plug is conical.

9. (canceled)
